(19) United States
(12) Patent Application Publication
(10) Pub. No.: US 2004/0120087 A1
(43) Pub. Date: Jun. 24, 2004

(54) Semiconductor device including a plurality of power domains

(76) Inventor: Hirotomo Ishii, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/670,342

(22) Filed: Sep. 26, 2003

(30) Foreign Application Priority Data
Sep. 27, 2002 (JP) 2002-284329

(51) Int. Cl. H02H 9/00

(52) U.S. Cl. 361/56

(57) ABSTRACT

A semiconductor device includes a first circuit block, the first circuit block having a first power supply terminal and a first ground terminal, a second circuit block, the second circuit block having a second power supply terminal and a second ground terminal, and a propagation circuit provided between an output terminal of the first circuit block and an input terminal of the second circuit block to propagate a signal. In the device, a signal input element connected to the input terminal of the second circuit block to which the signal is input through the propagation circuit has an input withstanding voltage which is higher than that of other elements of the second circuit block.

### CROSS-REFERENCE TO RELATED APPLICATIONS

This application is based upon and claims the benefit of priority from the prior Japanese Patent Application No. 2002-284329, filed Sep. 27, 2002, the entire contents of which are incorporated herein by reference.

### BACKGROUND OF THE INVENTION

1. Field of the Invention

The present invention relates to a semiconductor device including a plurality of power domains. More specifically, the invention relates to a semiconductor integrated circuit in which signals propagate between circuit blocks belonging to their different power domains.

2. Description of the Related Art

Prior art semiconductor integrated circuits need to be prevented from malfunctioning and degrading in performance due to interference and noise between circuit blocks mounted on the same chip. To do so, mutually independent power supply terminals are sometimes provided for circuit blocks whose functions differ from each other even though the same power supply voltage is applied to the circuit blocks (see, for example, Jpn. Pat. Appln. KOKOKU Publication No. 6-5705).

In semiconductor integrated circuits, normally, the number of elements integrated on a single chip increases in accordance with the progress of microfabrication technology, as does the number of circuit blocks mounted thereon. It is thus assumed that the need for separating power domains is intensified increasingly. In a semiconductor integrated circuit including a plurality of power domains, generally, an ESD (electrostatic discharge) protection network is formed among the power domains. Thus, an element in the circuit blocks is prevented from being broken by electrostatic discharge.

FIG. 7 shows a prior art semiconductor integrated circuit wherein a plurality of power domains are provided on the same chip. Referring to FIG. 7, a first power domain 101 comprises a power supply terminal (VDD) 102, a ground terminal (VSS) 103 and a first circuit 104. A second power domain 201 includes a power supply terminal 202, a ground terminal 203 and a second circuit 204. A third power domain 301 includes a power supply terminal 302, a ground terminal 303 and a third circuit 304. The first, second and third circuits 104, 204 and 304 are connected to each other by one or some of signal lines 401, 402 and 403 for propagating signals between them.

The power supply terminals 102, 202 and 302 and ground terminals 103, 203 and 303 are provided independently of one another. The power supply terminals 102, 202 and 302 are connected to terminals 602, 604 and 606 of an ESD protection network 601 via power supply wires 501, 503 and 505, respectively. The ground terminals 103, 203 and 303 are connected to terminals 603, 605 and 607 of the ESD protection network 601 via power supply wires 502, 504 and 506, respectively. In FIG. 5, R1, R2, R3, R4, R5 and R6 denote parasitic resistors of the power supply wires 501, 502, 503, 504, 505 and 506, respectively.

The ESD protection network 601 prevents the first, second and third circuits 104, 204 and 304 from being broken by electrostatic discharge. More specifically, an ESD current flows from a terminal to another terminal. The ESD protection network 601 prevents a voltage generated between the two terminals from becoming such an excessive voltage as to break an element, thereby preventing the first, second and third circuits 104, 204 and 304 from being broken.

In the foregoing prior art semiconductor integrated circuit, all of the terminals 102, 103, 202, 203, 302 and 303 are independent of one another. However, any two or more of the power supply terminals 102, 202 and 302 can be connected to each other to serve as a common terminal or any two or more of the ground terminals 103, 203 and 303 can be connected to each other to serve as a common terminal. The semiconductor integrated circuit shown in FIG. 7 is arranged to include three power domains 101, 201 and 301; however, it can be done in a different fashion.

FIG. 8 shows a relationship between voltage and current between two terminals in the ESD protection network 601 shown in FIG. 7. In FIG. 8, a dotted line 611 indicates a high equivalent parasitic resistance and a solid line 612 indicates a low equivalent parasitic resistance.

The equivalent parasitic resistance is a parameter for characterizing voltage characteristics in a region where the current flowing through the protection element is larger than I1. In this region, a relationship between voltage Vclamp at both ends of the protection element and current Iclamp flowing through the protection element can be expressed by the following equation (1):

Vclamp=Iclamp×Resd+VH (1)

where Resd is equivalent parasitic resistance and VH is a holding voltage of the protection element.

Usually, the holding voltage VH depends upon the three-dimensional structure of the protection element. In general, the larger the area of the protection element, the lower the equivalent parasitic resistance Resd. In a specific manufacturing process, the three-dimensional structure of the protection element is difficult to change, whereas the area of the protection element can arbitrarily be set. In other words, it is easy to increase the width of the protection element (in the direction perpendicular to the direction in which the current flows) or connect a plurality of protection elements in parallel such that the equivalent parasitic resistance Resd has a desired value.

The ESD stress on the semiconductor integrated circuit shown in FIG. 7 will now be discussed. As one example, an ESD current flows between the power supply terminal 102 and ground terminal 203. Though other combinations of the terminals are possible, their discussions are omitted.

As shown in FIG. 9, an ESD current flows from the power supply terminal 102 to the ground terminal 203 through a current path 701 in the semiconductor integrated circuit shown in FIG. 7. In other words, the ESD current flows from the power supply terminal 102 to the terminal 602 of the ESD protection network 601 through the parasitic resistor R1 of the power supply wire 501. Then, the ESD current flows through the protection element in the ESD protection network 601. After that, the ESD current flows to the ground terminal 203 from the terminal 605 through the parasitic resistor R4 of the power supply wire 504.

Assume here that the ESD current is Iesd, the characteristics between the terminals 602 and 605 of the ESD protection network 601 are ones indicated by a solid line 612 in FIG. 8, and their equivalent parasitic resistance is Resd. The voltage Vesd between the power supply terminal 102 and ground terminal 203 is expressed by the following equation:

Vesd=Iesd×(R1+R4+Resd)+VH (2).

The application of the voltage Vesd, which is given by the above equation (2), to the semiconductor integrated circuit so arranged will now be described.

FIG. 10 shows an extracted portion of only the first and second power domains 101 and 201 in the semiconductor integrated circuit shown in FIG. 7. In FIG. 10, a signal is output from an inverter INV1 that is made up of MOS transistors MP1 and MN1 in the first circuit 104 and input to an inverter INV2 that is made up of MOS transistors MP2 and MN2 in the second circuit 204.

The first circuit 104 includes an inverter INV1 that is made up of NMOS and PMOS transistors MN1 and MP1. The first circuit 104 outputs a signal from the inverter INV1 to the signal line 401. The second circuit 204 includes a first inverter INV2 that is made up of NMOS and PMOS transistors MN2 and MP2 and a second inverter INV3 that is made up of NMOS and PMOS transistors MN3 and MP3. The signal output from the first circuit 104 is supplied to the first inverter INV2 in the second circuit 204 through the signal line 401.

When the voltage Vesd given by the above equation (2) is applied to the semiconductor integrated circuit shown in FIG. 10, the potential of the signal line 401 is considered to be one between the power supply terminal 102 and ground terminal 203. Thus, the maximum potential of the signal line 401 becomes almost equal to the potential of the power supply terminal 102. The potential of the signal line 401 is applied to the gate of the NMOS transistor MN2 in the second circuit 204 as it is.

On the other hand, since the source of the NMOS transistor MN2 is connected to the ground terminal 203, the potential of the source is equal to that of the ground terminal 203. Consequently, the gate-to-source voltage of the NMOS transistor MN2 is a voltage that is equal to the potential between the power supply terminal 102 and ground terminal 203 at the maximum, i.e., a voltage Vesd. When the voltage Vesd exceeds the breakdown voltage of the gate of the NMOS transistor MN2, the problem that a gate oxide is broken by ESD event occurs.

Like FIG. 10, FIG. 11 shows an extracted portion of only the first and second power domains 101 and 201 in the semiconductor integrated circuit shown in FIG. 7. In FIG. 11, however, a signal is output from an output circuit OC1 that is made up of MOS transistors MP11 and MN11 in the first circuit 104 and input to an input circuit AS1 that is made up of MOS transistors MP14 and MN14 in the second circuit 204.

The first circuit 104 includes an output circuit OC1 that is made up of an NMOS transistor MN11 and a PMOS transistor MP11. The first circuit 104 also includes a circuit OC2 that is made up of an NMOS transistor MN12 and a PMOS transistor MP12. The circuit OC2 is arranged in the stage precedent to the NMOS transistor MN11. The first circuit 104 also includes a circuit OC3 that is made up of an NMOS transistor MN13 and a PMOS transistor MP13. The circuit OC3 is arranged in the stage precedent to the PMOS transistor MP11. The first circuit 104 outputs a signal to the signal line 401 from a common drain of the NMOS and PMOS transistors MN11 and MP11. In FIG. 11, R11 and R12 denote parasitic resistors of power supply wires connected to the power supply terminal 102 and ground terminal 103. The second circuit 204 includes an analog switch (input circuit) AS1 that is made up of an NMOS transistor MN14 and a PMOS transistor MP14. The signal output from the first circuit 104 is supplied to a connection node of the drains of the NMOS and PMOS transistors MN14 and MP14 in the second circuit 204 through the signal line 401.

In the semiconductor integrated circuit shown in FIG. 11, a signal flowing between the first and second power domains 101 and 201 is supplied to a common drain of the NMOS and PMOS transistors MN14 and MP14. Therefore, when an ESD event occurs in the semiconductor integrated circuit shown in FIG. 11, there occurs a problem different from that of the semiconductor integrated circuit shown in FIG. 10. For example, when an ESD current flows from the power supply terminal 102 to the ground terminal 203, it flows through the current path 701 shown in FIG. 9 as in the semiconductor integrated circuit shown in FIG. 10. Consequently, the voltage Vesd given by the above equation (2) is generated as in the semiconductor integrated circuit shown in FIG. 10. In addition, it is assumed that the additional ESD current flows through a PN junction in each of the first and second circuits 104 and 204.

The additional ESD current flows from the power supply terminal 102 to the terminal 604 of the ESD protection network 601 through the parasitic resistor R11 of the power supply wire, the parasitic bipolar (PNP) transistor that is made up of the source, N-well and drain of the PMOS transistor MP11, the parasitic diode that is made up of the drain and N-well of the PMOS transistor MP14, and the parasitic resistor R3 of the power supply wire 503, like a current path 702 shown in FIG. 12. Then, the additional ESD current passes through the protection element in the ESD protection network 601 and flows to the ground terminal 203 from the terminal 605 through the parasitic resistor R4 of the power supply wire 504. The value of the additional ESD current depends upon the voltage Vesd expressed by the above equation (2) and the characteristics of the parasitic diode and parasitic bipolar transistor.

The parasitic diode and parasitic bipolar transistor have an allowable current value that depends upon the dimensions of an element. There occurs a problem that a PN junction is broken due to the additional ESD current whose value exceeds the allowable current value and thus does not operate normally as a MOS transistor.

In the semiconductor integrated circuit shown in FIG. 11, another problem is caused by the current path 702 and parasitic resistor R11. For example, when an additional ESD current flows through the current path 702, a voltage drops at both ends of the parasitic resistor R11. It is considered that the potential of the drain of the PMOS transistor MP13 is present between the power supply terminal 102 and ground terminal 103 in a steady state and follows a transient change in the potential of the power supply terminal 102 because of the parasitic capacitance. In other words, due to the voltage drop at both ends of the parasitic resistor R11, the potential of the power supply terminal 102 increases relative to that of the source of the PMOS transistor MP11; consequently, the potential of the drain of the PMOS transistor MP13 increases. Since the drain of the PMOS transistor MP13 is connected to the gate of the PMOS transistor MP11, the potential of the gate of the PMOS transistor MP11 increases relative to that of the source of the PMOS transistor MP11. Thus, when the voltage generated at both ends of the parasitic resistor R11 is almost higher than the breakdown voltage of the gate of the PMOS transistor MP11, there occurs a problem that the gate oxide of the PMOS transistor MP11 is broken by electrostatic discharge.

When the ESD protection network protects a circuit in a chip from the ESD event as described above, there is a case where the circuit cannot be protected if the parasitic resistance of the power supply wire extending to the ESD protection network is high and so is the equivalent parasitic resistance of the ESD protection network. As measures against this case, it is evidently effective to expand the power supply wire (widen the wire) and lower the equivalent parasitic resistance by increasing the size of the protection element. However, these measures result increasing the area of the chip and thus the costs of the chip.

When the number of power domains in the same chip increases or a circuit sensitive to noise is arranged separately from a noise source, there is a case where circuits having different power domains are arranged separately from each other on the chip. In this case, the power supply wire extending to the ESD protection network is likely to be lengthened. In order to make the parasitic resistance of a wire not higher than a given value in terms of the protection against ESD, however, a longer power supply wire needs to be wider than a shorter power supply wire. Consequently, the area of the chip greatly increases as the power supply wire expands and accordingly the measures against ESD become very difficult to take.

### BRIEF SUMMARY OF THE INVENTION

According to a first aspect of the present invention, there is provided a semiconductor device comprising: a first circuit block including a first power supply terminal and a first ground terminal, a first power supply voltage being applied between the first power supply terminal and the first ground terminal from a first power domain; a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and a propagation circuit provided between an output terminal of the first circuit block and an input terminal of the second circuit block to propagate a signal, wherein: at least the second circuit block includes a plurality of elements having an equal input withstanding voltage; the first circuit block includes a plurality of elements whose withstanding voltage is equal to or lower than that of the elements of the second circuit block; and a signal input element connected to the input terminal of the second circuit block to which the signal is input through the propagation circuit has an input withstanding voltage which is higher than that of other elements of the second circuit block.

According to a second aspect of the present invention, there is provided a semiconductor device comprising: a first circuit block including a first power supply terminal and a first ground terminal, a first power supply voltage being applied between the first power supply terminal and the first ground terminal from a first power domain; a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and a propagation circuit provided between an output terminal of the first circuit block and an input terminal of the second circuit block to propagate a signal, wherein: the propagation circuit includes a resistive element connected between the output terminal of the first circuit block and the input terminal of the second circuit block.

According to a third aspect of the present invention, there is provided a semiconductor device comprising: a first circuit block including a first power supply terminal and a first ground terminal, a first power supply voltage being applied between the first power supply terminal and the first ground terminal from a first power domain; a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and a propagation circuit provided between an output terminal of the first circuit block and an input terminal of the second circuit block to propagate a signal, wherein: the first and second circuit blocks are each made up of a plurality of elements having an equal input withstanding voltage; and at least one of the elements of the first circuit block, to which such an excessive voltage as to break the elements by electrostatic discharge is applied, has an input withstanding voltage that is higher than that of other elements which make up the first circuit block, or at least one of the elements of the second circuit block, to which such an excessive voltage as to break the elements by electrostatic discharge is applied, has an input withstanding voltage that is higher than that of other elements which make up the second circuit block.

### BRIEF DESCRIPTION OF THE SEVERAL VIEWS OF THE DRAWING

FIG. 1 is a circuit diagram showing an example of a semiconductor integrated circuit according to a first embodiment of the present invention.

FIG. 2 is a circuit diagram showing an example of a semiconductor integrated circuit according to a second embodiment of the present invention.

FIG. 3 is a circuit diagram showing an example of a semiconductor integrated circuit according to a third embodiment of the present invention.

FIG. 4 is a circuit diagram showing another example of the semiconductor integrated circuit according to the third embodiment of the present invention.

FIG. 5 is a circuit diagram showing an example of a semiconductor integrated circuit according to a fourth embodiment of the present invention.

FIG. 6 is a circuit diagram showing another example of the semiconductor integrated circuit according to the fourth embodiment of the present invention.

FIG. 7 is a circuit diagram showing a prior art semiconductor integrated circuit and describing its problems.

FIG. 8 is a graph showing a relationship between a voltage and a current between two terminals in an ESD protection network of the semiconductor integrated circuit shown in FIG. 7.

FIG. 9 is a circuit diagram showing an example of an ESD current is applied to the semiconductor integrated circuit shown in FIG. 7.

FIG. 10 is a circuit diagram showing a specific example of the semiconductor integrated circuit shown in FIG. 7.

FIG. 11 is a circuit diagram showing another specific example of the semiconductor integrated circuit shown in FIG. 7.

FIG. 12 is a circuit diagram showing an example of an ESD current is applied to the semiconductor integrated circuit shown in FIG. 11.

### DETAILED DESCRIPTION OF THE INVENTION

(First Embodiment)

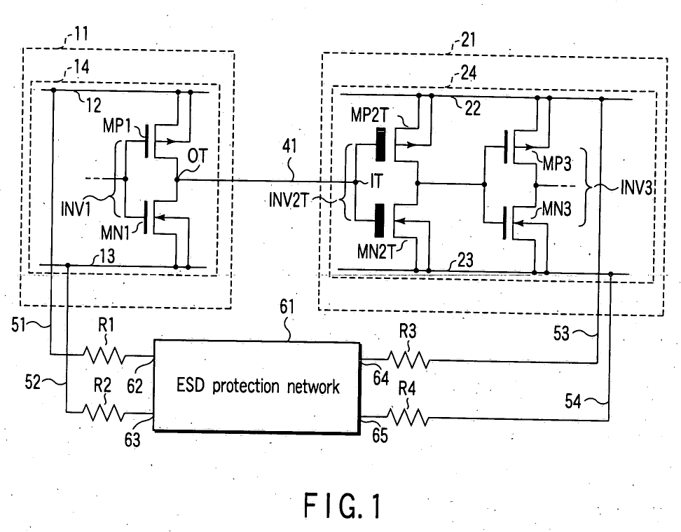

FIG. 1 shows an example of a semiconductor integrated circuit according to a first embodiment of the present invention. This semiconductor integrated circuit includes a first power domain and a second power domain.

Referring to FIG. 1, a first power domain 11 includes a power supply terminal (VDD) 12 serving as a first power supply terminal, a ground terminal (VSS) 13 serving as a first ground terminal and a first circuit (first circuit block) 14. The first circuit 14 is operated by a first power supply voltage that is applied from the first power domain 11 to the power supply terminal 12 and ground terminal 13. A second power domain 21 includes a power supply terminal 22 serving as a second power supply terminal, a ground terminal 23 serving as a second ground terminal and a second circuit (second circuit block) 24. The second circuit 24 is operated by a second power supply voltage that is applied from the second power domain 21 to the power supply terminal 22 and ground terminal 23. The first and second circuits 14 and 24 are connected to each other by at least one signal line (propagation circuit) 41.

The power supply terminals 12 and 22 are provided independently of each other, as are the ground terminals 13 and 23. The power supply terminal 12 is connected to a terminal 62 of an ESD protection network 61 through a power supply wire 51. The ground terminal 13 is connected to a terminal 63 of the ESD protection network 61 through a power supply wire 52. The power supply terminal 22 is connected to a terminal 64 of the ESD protection network 61 through a power supply wire 53. The ground terminal 23 is connected to a terminal 65 of the ESD protection network 61 through a power supply wire 54. In FIG. 1, R1, R2, R3 and R4 indicate parasitic resistors of the power supply wires 51, 52, 53 and 54, respectively.

In the ESD protection network 61, when an ESD current flows from a terminal to another terminal, an internal protection element (not shown) prevents an excessive voltage from being applied to the first and second circuits 14 and 24 and thus prevents these circuits 14 and 24 from being broken by electrostatic discharge.

In the first embodiment, the first circuit 14 includes an inverter (output circuit) INV1 that is made up of an NMOS transistor MN1 and a PMOS transistor MP1. The first circuit 14 supplies a signal to the signal line 41 from the output terminal OT of the inverter INV1.

On the other hand, the second circuit 24 includes a first inverter (input circuit) INV2T that is made up of an NMOS transistor MN2T and a PMOS transistor MP2T that serve as signal input elements. The second circuit 24 also includes a second inverter INV3 that is made up of an NMOS transistor MN3 and a PMOS transistor MP3. The signal output from the output terminal OT of the first circuit 14 is supplied to the input terminal IT of the inverter INV2T in the second circuit 24 through the signal line 41.

The NMOS and PM0S transistors MN2T and MP2T of the first inverter INV2T in the second circuit 24 are each formed of an element whose gate breakdown voltage is higher than that of other elements (Va>Vb if the gate breakdown voltage of MN2T and MP2T is Va and that of MN1, MP1, MN3 and MP3 is Vb). The gate oxides of the NMOS and PMOS transistors MN2T and MP2T can thus be prevented from being broken by electrostatic discharge even though a high voltage (excessive voltage), which is generated by applying an ESD current to the semiconductor integrated circuit, is applied to the gates of the transistors MN2T and MP2T.

The first embodiment is directed to a case where the first and second circuits 14 and 24 can be made up of a plurality of elements having the same gate breakdown voltage (input withstanding voltage). In this case, for example, the first power supply voltage of the first power domain 11 and the second power supply voltage of the second power domain 21 may be equal to each other. The power supply voltages of the systems 11 and 21 need not be always identical with each other. In the semiconductor integrated circuit shown in FIG. 1, the NMOS and PMOS transistors MN2 and MP2 shown in, e.g., FIG. 10 are replaced with the NMOS and PMOS transistors MN2T and MP2T whose gate breakdown voltage is higher. These NMOS and PMOS transistors MN2T and MP2T can easily be implemented by making their gate oxides thicker than other elements.

Elements whose gate breakdown voltages vary from circuit to circuit can easily be used in the same chip by adopting the recent manufacturing process. Since the power supply voltage of the internal circuit of a chip is generally about 1.5 V or lower, an element whose gate breakdown voltage corresponds to the power supply voltage is used. In contrast, since the power supply voltage of an input/output (I/O) circuit used for interfacing with the outside of a chip is about 2.5 V, an element whose gate breakdown voltage is higher than that of the internal circuit of the chip is used in the I/O circuit. According to the recent manufacturing process, when an element whose gate breakdown voltage is higher than that of the internal circuit is normally used in the same chip, an element whose gate breakdown voltage is partly higher than that of another internal circuit can be formed even in the internal circuit. In this case, no manufacturing costs are increased.

In a semiconductor integrated circuit that propagates a signal between circuits in different power domains as in the first embodiment, an element that is supplied with signals from the circuits in the different power domains is formed of a MOS transistor whose gate breakdown voltage is higher than that of another element. Thus, the gate becomes harder to break by electrostatic discharge than that of the prior art semiconductor integrated circuit. Consequently, any special manufacturing process for the same protection against ESD as that in the prior art semiconductor integrated circuit is not required and an ESD immunity level can be increased. More specifically, even when measures against ESD is taken by the same ESD protection network as that of the prior art and the power supply wire having the same parasitic resistance as that of the prior art without widening the power supply wire or increasing the protection element in size, an ESD immunity level can be improved without enlarging the chip area or increasing the chip costs.

If, moreover, the power supply wire is widened and the protection element is downsized more than those in the prior art, the gate becomes hard to break by electrostatic discharge even though the parasitic resistance of the power supply wire and the equivalent parasitic resistance of the protection element are increased. The semiconductor integrated circuit according to the first embodiment therefore has the advantages that the same ESD immunity level as that in the prior art circuit can be obtained by a smaller chip and the costs of the chip can be lowered.

The first embodiment is not limited to the semiconductor integrated circuit shown in FIG. 1. For example, it can be applied to a semiconductor integrated circuit in which a signal output from a circuit in a power domain is supplied to the gate of a MOS transistor in another power domain.

(Second Embodiment)

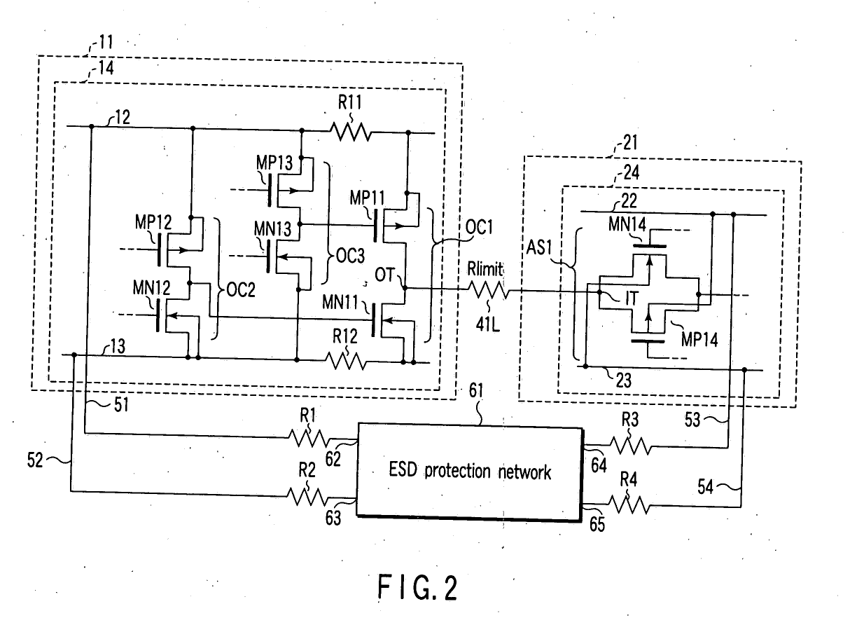

FIG. 2 shows an example of a semiconductor integrated circuit according to a second embodiment of, the present invention. In this example, a signal output from an output circuit in a power domain is supplied to a PN junction of, e.g., the drain of a MOS transistor of an input circuit in another power domain.

Referring to FIG. 2, a first power domain 11 includes a power supply terminal (VDD) 12 serving as a first power supply terminal, a ground terminal (VSS) 13 serving as a first ground terminal and a first circuit (first circuit block) 14. The first circuit 14 is operated by a first power supply voltage that is applied from the first power domain 11 to the power supply terminal 12 and ground terminal 13. A second power domain 21 includes a power supply terminal 22 serving as a second power supply terminal, a ground terminal 23 serving as a second ground terminal and a second circuit (second circuit block) 24. The second circuit 24 is operated by a second power supply voltage that is applied from the second power domain 21 to the power supply terminal 22 and ground terminal 23. The first and second circuits 14 and 24 are connected to each other by at least one signal line (propagation circuit) 41L.

The power supply terminal 12 and ground terminal 13 are provided independently of each other, as are the power supply terminal 22 and ground terminal 23. The power supply terminal 12 is connected to a terminal 62 of an ESD protection network 61 through a power supply wire 51. The ground terminal 13 is connected to a terminal 63 of the ESD protection network 61 through a power supply wire 52. The power supply terminal 22 is connected to a terminal 64 of the ESD protection network 61 through a power supply wire 53. The ground terminal 23 is connected to a terminal 65 of the ESD protection network 61 through a power supply wire 54. In FIG. 2, R1, R2, R3 and R4 indicate parasitic resistors of the power supply wires 51, 52, 53 and 54.

In the ESD protection network 61, when an ESD current flows from a terminal to another terminal, an internal protection element (not shown) prevents an excessive voltage from being applied to the first and second circuits 14 and 24 and thus prevents these circuits 14 and 24 from being broken by electrostatic discharge.

In the second embodiment, the first circuit 14 includes an output circuit OC1 that is made up of an NMOS transistor MN11 and a PMOS transistor MP11. The first circuit 14 also includes a circuit OC2 that is made up of an NMOS transistor MN12 and a PMOS transistor MP12. The circuit OC2 is arranged in the stage precedent to the NMOS transistor MN11. The first circuit 14 also includes a circuit OC3 that is made up of an NMOS transistor MN13 and a PMOS transistor MP13. The circuit OC3 is arranged in the stage precedent to the PMOS transistor MP11. The first circuit 14 outputs a signal to the signal line 41L from a common drain (output terminal OT) of the NMOS and PMOS transistors MN11 and MP11. In FIG. 2, R11 and R12 denote parasitic resistors of power supply wires connected to the power supply terminal 12 and ground terminal 13.

The second circuit 24 includes an analog switch (input circuit) AS1 that is made up of an NMOS transistor MN14 and a PMOS transistor MP14. The signal output from the output terminal OT of the first circuit 14 is supplied to the a connection node (input terminal IT) of the drains of the NMOS and PMOS transistors MN14 and MP14 in the second circuit 24 through the signal line 41L.

A resistive element Rlimit is provided halfway in the signal line 41L. In other words, the resistive element Rlimit is inserted between the output terminal OT and input terminal IT. Thus, even if an ESD current is applied to the semiconductor integrated circuit, an additional ESD current flowed to a common drain of the NMOS and PMOS transistors MN14 and MP14 can be reduced. Any element having resistive characteristics can be used as the resistive element Rlimit and any special manufacturing process is not needed. The signal line 41L can easily be implemented without increasing in manufacturing costs by forming an element having resistive characteristics halfway in the signal line.

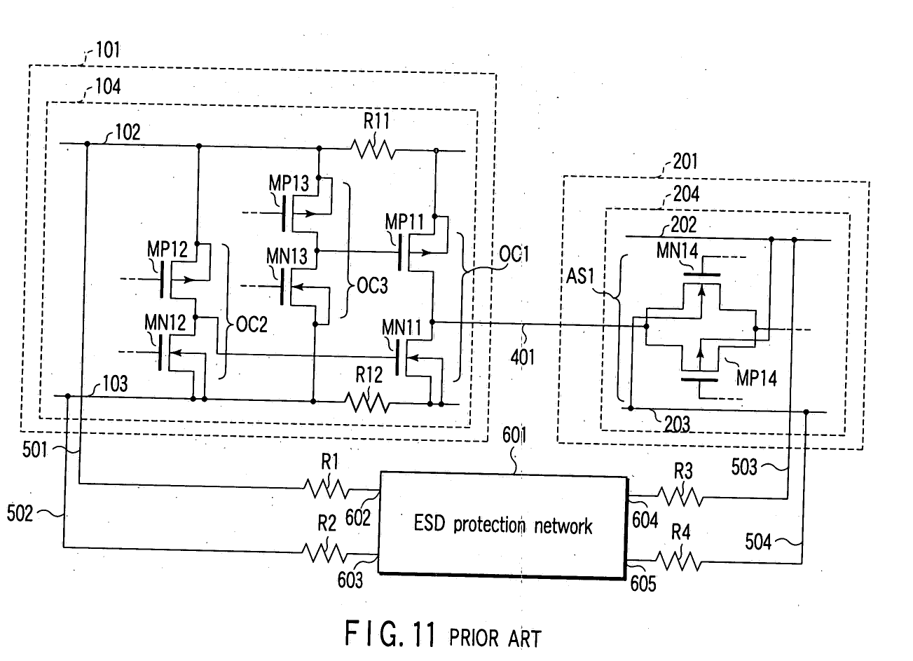

The second embodiment is directed to a case where the first and second circuits 14 and 24 can be made up of a plurality of elements having the same gate breakdown voltage (input withstanding voltage). In this case, for example, the first power supply voltage of the first power domain 11 and the second power supply voltage of the second power domain 21 may be equal to each other. The power supply voltages of the systems 11 and 21 need not be always identical with each other. In the semiconductor integrated circuit shown in FIG. 2, the signal line 41L with the resistive element Rlimit is used in place of the signal line 401 shown in, for example, FIG. 11.

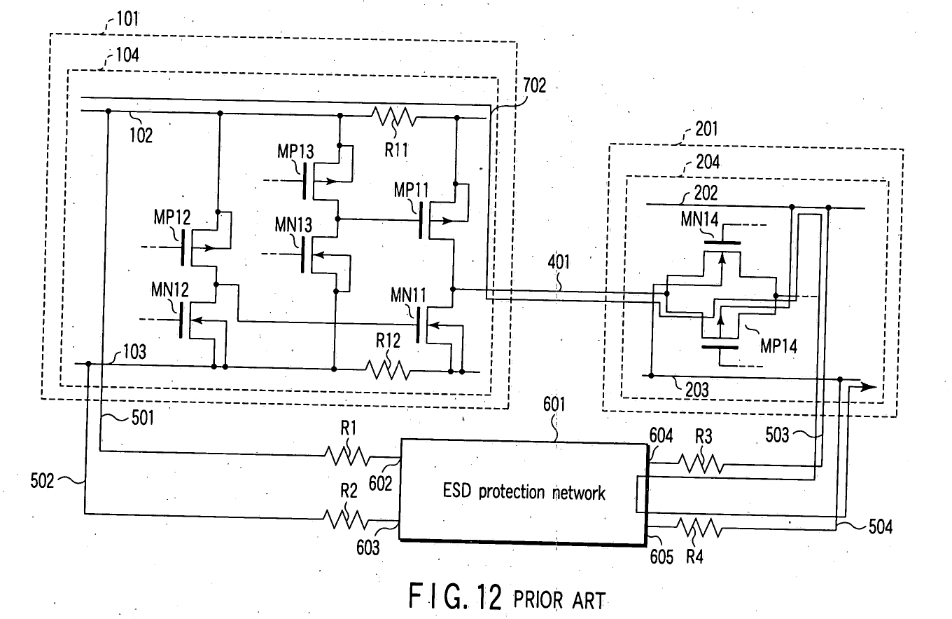

As described above, the common drain of the NMOS and PMOS transistors MN11 and MP11 that make up the output circuit OC1 and that of the NMOS and PMOS transistors MN14 and MP14 that make up the input circuit AS1 are connected to each other using the signal line 41L including the resistive element Rlimit. In this case, too, an ESD current flows through a current path 702 as shown in FIG. 12 when an ESD event occurs in the semiconductor integrated circuit. The additional ESD current is however decreased by the resistive element Rlimit in the signal line 41L. Thus, the PN junction becomes harder to break than that of the prior art semiconductor integrated circuit. Consequently, though the area of the chip is slightly increased by the resistive element Rlimit, an ESD immunity level can be increased with almost no increase in the manufacturing costs.

The use of the signal line 41L with the resistive element Rlimit allows an ESD immunity level to be increased in the semiconductor integrated circuit in which a signal propagates between the circuits 14 and 24 in different power domains 11 and 21. Consequently, even though an additional ESD current flows through a parasitic bipolar transistor (first semiconductor region that forms a first PN junction) that is made up of the source, N-well and drain of the PMOS transistor MP11, the parasitic PN junction can be prevented from being broken by the additional ESD current. Similarly, even though an additional ESD current flows through a parasitic diode (second semiconductor region that forms a second PN junction) that is made up of the drain and N-well of the PMOS transistor MP14, the parasitic PN junction can be prevented from being broken by the additional ESD current.

In the second embodiment, the ESD immunity level can be increased with almost no increase in the chip area or the manufacturing costs as in the first embodiment described above. Moreover, the same ESD immunity level as that of the prior art semiconductor integrated circuit can be achieved at low costs.

The second embodiment is not limited to the semiconductor integrated circuit shown in FIG. 2. For example, it can be applied to a semiconductor integrated circuit in which a signal output from a circuit in a power domain is supplied to a PN junction of, e.g., the drain of a MOS transistor in another power domain.

(Third Embodiment)

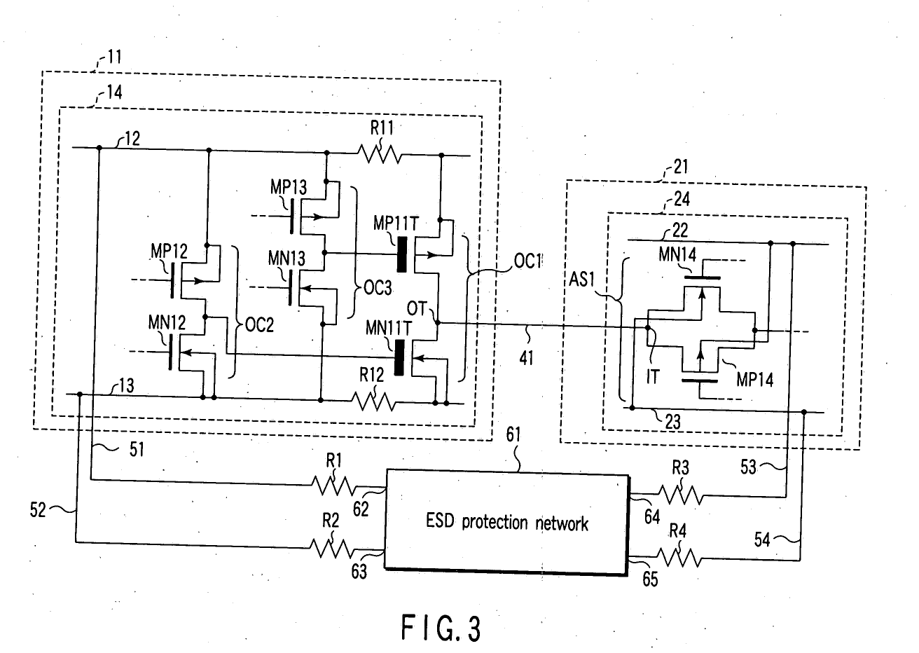

FIG. 3 shows an example of a semiconductor integrated circuit according to a third embodiment of the present invention. The third embodiment is directed to another example of the second embodiment in which a signal output from an output circuit in a power domain is supplied to a PN junction of, e.g., the drain of a MOS transistor of an input circuit in another power domain. The same components as those of the circuit shown in FIG. 2 are denoted by the same reference numerals and their detailed descriptions are omitted.

In the third embodiment, as shown in FIG. 3, a first circuit 14 and a second circuit 24 are connected to each other by at least one signal line (propagation circuit) 41. The first circuit 14 includes an output circuit OC1 that is made up of an NMOS transistor MN11T and a PMOS transistor MP11T. The first circuit 14 also includes a circuit OC2 that is made up of an NMOS transistor MN12 and a PMOS transistor MP12. The circuit OC2 is arranged in the stage precedent to the NMOS transistor MN11T. The first circuit 14 also includes a circuit OC3 that is made up of an NMOS transistor MN13 and a PMOS transistor MP13. The circuit OC3 is arranged in the stage precedent to the PMOS transistor MP11T. The first circuit 14 outputs a signal to the signal line 41 from a common drain (output terminal OT) of the NMOS and PMOS transistors MN11T and MP11T.

In the first circuit 14, the NMOS and PMOS transistors MN11T and MP11T of the output circuit OC1 are each formed of an element whose gate breakdown voltage is higher than that of other elements (Va′>Vb′ if the gate breakdown voltage of MN11T and MP11T is Va′ and that of MN12, MP12, MN13, MP13, MN14 and MP14 is Vb′). Therefore, when an ESD current is applied to the semiconductor integrated circuit, a gate oxide of the PMOS transistor MP11T can be prevented from being broken by a voltage drop caused at both ends of the parasitic resistor R1 even though an additional ESD current flows through the current path 702 shown in FIG. 12.

The third embodiment is directed to a case where the first and second circuits 14 and 24 can be made up of a plurality of elements having the same gate breakdown voltage (input withstanding voltage). In this case, for example, the first power supply voltage of the first power domain 11 and the second power supply voltage of the second power domain 21 may be equal to each other. The power supply voltages of the domains 11 and 21 need not be always identical with each other. In the semiconductor integrated circuit shown in FIG. 3, the NMOS and PMOS transistors MN11T and MP11T whose gate breakdown voltages are higher than those of the other elements are used in place of the NMOS and PMOS transistors MN11 and MP11 shown in FIG. 11. These transistors MN11T and MP11T can easily be implemented by making their thickness greater than that of the other elements.

In the third embodiment, too, an element whose gate breakdown voltage is higher than that of another internal circuit can easily be formed in the same chip by the recent manufacturing process as in the foregoing first embodiment. Accordingly, no manufacturing costs are increased.

As described above, in the semiconductor integrated circuit so arranged that a signal is supplied from the common drain of the NMOS and PMOS transistors MN11T and MP11T in the first power domain 11 to the PN junction of, e.g., the drains of the NMOS and PMOS transistors MN14 and MP14 in the second power domain 21, the breakdown voltage of the NMOS and PMOS transistors MN11T and MP11T is set higher than that of the other elements. Thus, the gate is harder to break by electrostatic discharge than that of the prior art semiconductor integrated circuit. Consequently, any special manufacturing process for the same ESD immunity level as that in the prior art semiconductor integrated circuit is not required and an ESD immunity level can be increased. In the third embodiment, too, the ESD immunity level can be increased without increasing the chip area or the chip costs. Moreover, the same ESD immunity level as that in the prior art semiconductor integrated circuit can be achieved at low costs.

The semiconductor integrated circuit according to the third embodiment is not limited to that shown in FIG. 3. For example, it can be applied to an integrated circuit in which a signal output from a MOS transistor in a power domain is supplied to a PN junction of, e.g., the drain of a MOS transistor in another power domain and an additional ESD current flows in the former MOS transistor through a parasitic resistor of a power supply line.

An element whose gate breakdown voltage is high can be used not only in the output circuit that outputs a signal but also in another circuit. For example, a circuit whose gate is broken by applying a high voltage by ESD can be formed by an element whose gate breakdown voltage is higher than that of the other elements.

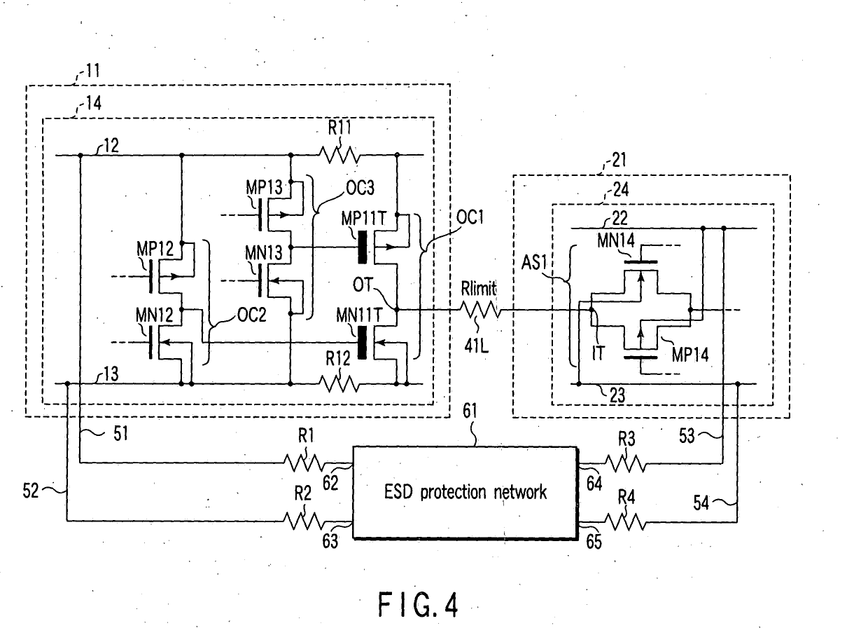

In particular, the semiconductor integrated circuit according to the second embodiment can be achieved in the semiconductor integrated circuit according to the third embodiment. In this case, as shown in FIG. 4, the MOS transistors MN11T and MP11T are formed by MOS transistors whose gate breakdown voltage is higher than that of the other elements. Simultaneously, the first and second circuits 14 and 24 are connected to each other by a signal line 41L in which a resistive element Rlimit is inserted.

With the above circuit arrangement, an ESD immunity level can be increased with almost no increase in chip area or chip costs. In other words, not only the same ESD immunity level as that in the prior art circuit can be achieved at low costs, but also a parasitic PN junction can be prevented from being broken by an ESD current and a gate oxide of the PMOS transistor MP11T can be prevented from being broken due to a voltage drop caused at both ends of the parasitic resistor R11.

(Fourth Embodiment)

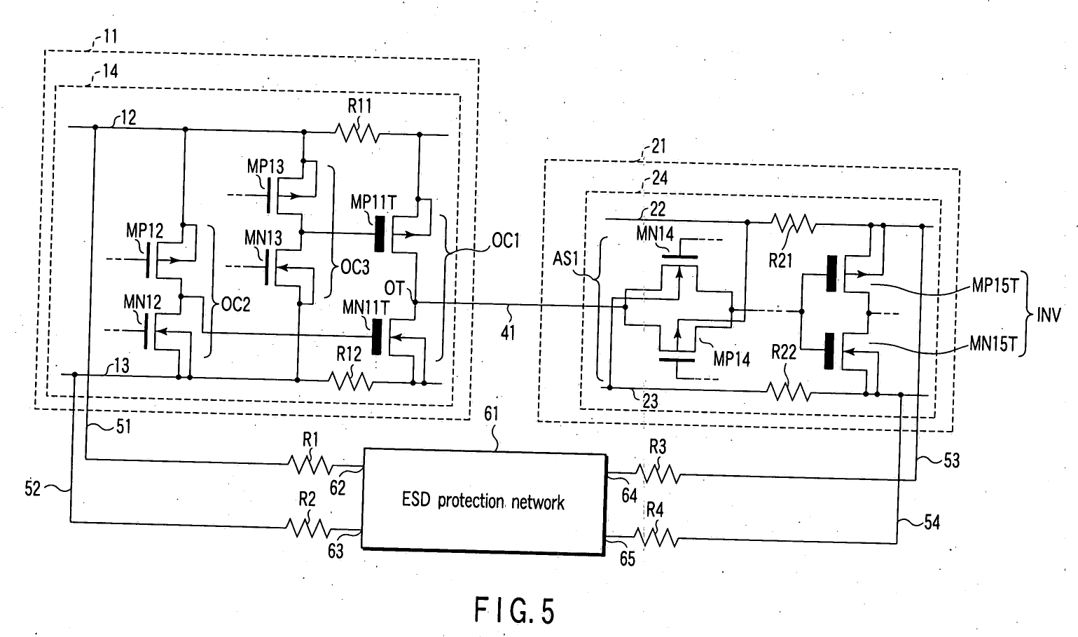

FIG. 5 shows an example of a semiconductor integrated circuit according to a fourth embodiment of the present invention. The fourth embodiment is directed to another example of the semiconductor integrated circuit shown in FIG. 3. The same components as those of the circuit shown in FIG. 3 are denoted by the same reference numerals and their detailed descriptions are omitted.

According to the fourth embodiment, in the semiconductor integrated circuit shown in FIG. 3, the second circuit 24 further includes an inverter INV. The inverter INV is made up of, for example, an NMOS transistor MN15T and a PMOS transistor MP15T. These transistors MN15T and MP15T are each formed of an element whose gate breakdown voltage is higher than that of other elements (Va′>Vb′ if the gate breakdown voltage of MN11T, MP11T, MN15T and MP15T is Val and that of MN12, MP12, MN13, MP13, MN14 and MP14 is Vb′), like the above NMOS transistor MN11T and PMOS transistor MP11T. The gate oxides of the NMOS and PMOS transistors MN15T and MP15T can thus be prevented from being broken by electrostatic discharge even though a high voltage (excessive voltage), which is generated by applying an ESD current to the semiconductor integrated circuit, is applied to the gates of the transistors MN15T and MP15T. In FIG. 5, R21 and R22 indicate the parasitic resistance of a power supply line connected to the power supply terminal 22 and that of a power supply line connected to the power supply terminal 23, respectively.

With the above circuit arrangement, an ESD immunity level can be increased with almost no increase in chip area or chip costs. In other words, not only the same ESD immunity level as that in the prior art circuit can be achieved at low costs, but also a parasitic PN junction can be prevented from being broken by an additional ESD current, and a gate oxide of the PMOS transistor MP11T can be prevented from being broken due to a voltage drop caused at both ends of the parasitic resistor R11 and a gate oxide of the PMOS transistor MP15T can be prevented from being broken due to a voltage drop caused at both ends of the parasitic resistor R21.

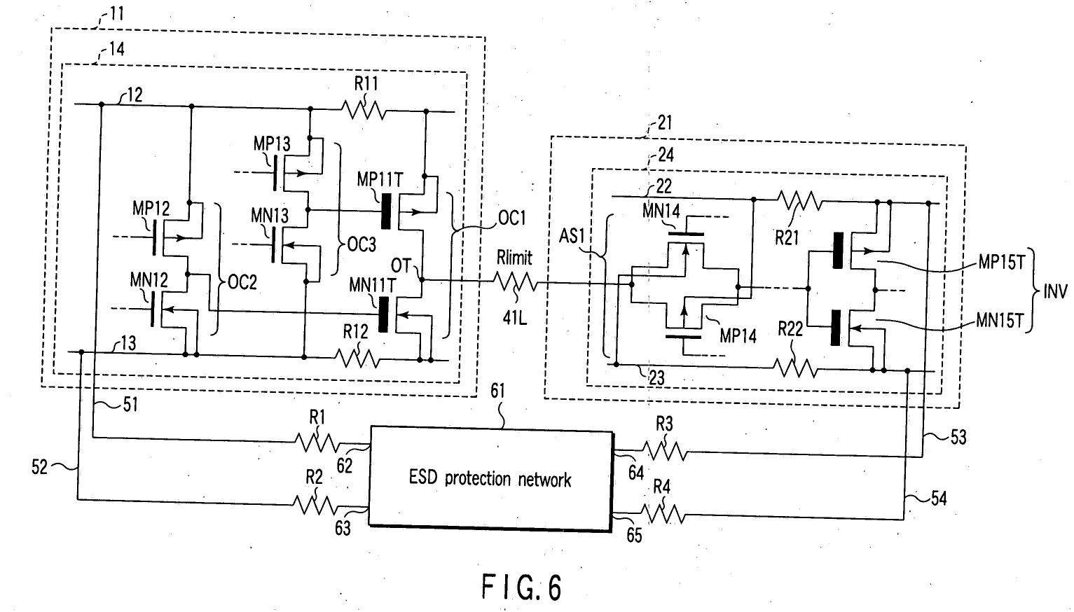

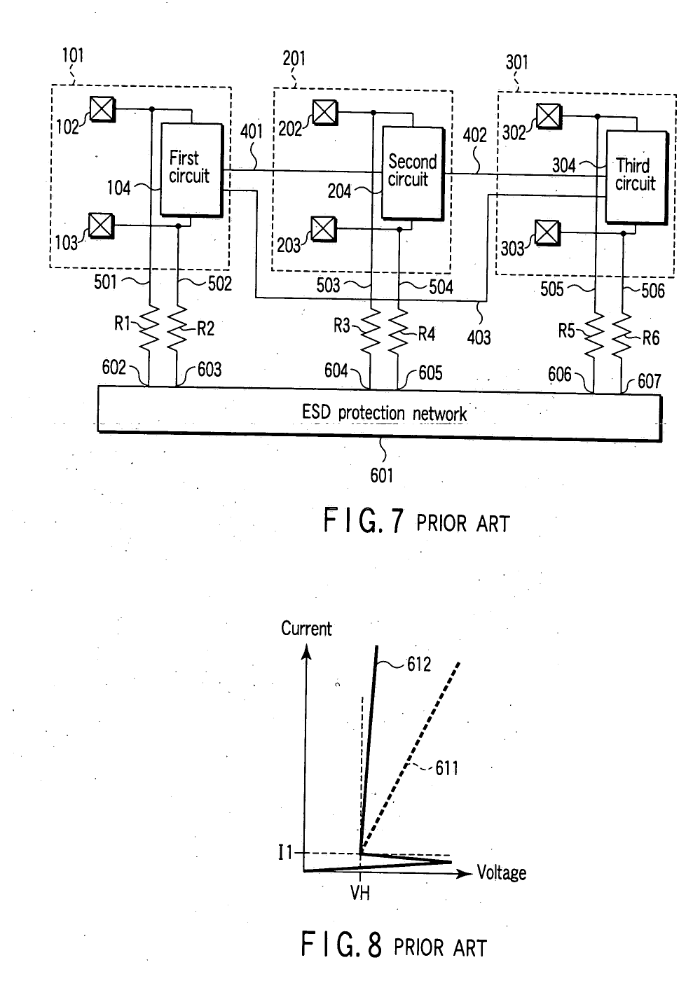

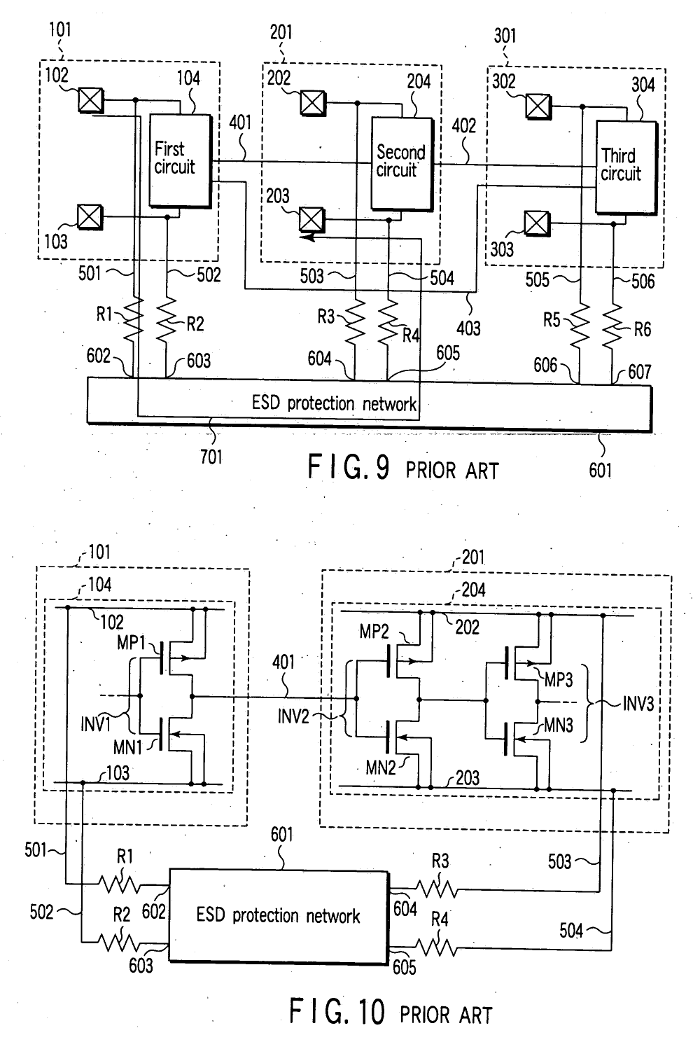

Furthermore, the semiconductor integrated circuit according to the fourth embodiment can be applied to the semiconductor integrated circuit shown in FIG. 4. In this case, as shown in FIG. 6, the inverter INV is formed by using MOS transistors MN15T and MP15T whose gate breakdown voltage is higher than that of the other elements in the second circuit 24. Simultaneously, the first and second circuits 14 and 24 are connected to each other by a signal line 41L in which a resistive element Rlimit is inserted.

With the above circuit arrangement, too, an ESD immunity level can be increased with almost no increase in chip area or chip costs. In other words, not only the same ESD immunity level as that in the prior art circuit can be achieved at low costs, but also a parasitic PN junction can be prevented from being broken by an additional ESD current, and a gate oxide of the PMOS transistor MP11T can be prevented from being broken due to a voltage drop caused at both ends of the parasitic resistor R11 and a gate oxide of the PMOS transistor MP15T can be prevented from being broken due to a voltage drop caused at both ends of the parasitic resistor R21.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device comprising:
a first circuit block including a first power supply terminal and a first ground terminal, a first power supply voltage being applied between the first power supply terminal and the first ground terminal from a first power domain;
a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and
a propagation circuit provided between an output terminal of the first circuit block and an input terminal of the second circuit block to propagate a, signal,
wherein:
at least the second circuit block includes a plurality of elements having an equal input withstanding voltage;
the first circuit block includes a plurality of elements whose withstanding voltage is equal to or lower than that of the elements of the second circuit block; and
a signal input element connected to the input terminal of the second circuit block to which the signal is input through the propagation circuit has an input withstanding voltage which is higher than that of other elements of the second circuit block.

2. The semiconductor device according to claim 1, wherein the propagation circuit is a signal line which makes a short circuit between the output terminal of the first circuit block and the input terminal of the second circuit block.

3. The semiconductor device according to claim 1, wherein the elements of the second circuit block are a plurality of MOS transistors.

4. The semiconductor device according to claim 3, wherein a gate oxide of a MOS transistor that forms a signal input element is thicker than that of another MOS transistor that forms another element.

5. The semiconductor device according to claim 1, wherein the first power supply voltage and the second power supply voltage are equal to each other.

6. The semiconductor device according to claim 1, wherein the first power supply voltage and the second power supply voltage differ from each other.

7. The semiconductor device according to claim 1, further comprising an electrostatic discharge protection circuit connected to the first and second power supply terminals and the first and second ground terminals.

8. A semiconductor device comprising:
a first circuit block including a first power supply terminal and a first ground terminal, a first power supply voltage being applied between the first power supply terminal and the first ground terminal from a first power domain;
a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and
a propagation circuit provided between an output terminal of the first circuit block and an input terminal of the second circuit block to propagate a signal,
wherein:
the propagation circuit includes a resistive element connected between the output terminal of the first circuit block and the input terminal of the second circuit block.

9. The semiconductor device according to claim 8, wherein the propagation circuit is a signal line which connects a first semiconductor region which forms a first PN junction in the first circuit block and a second semiconductor region which forms a second PN junction in the second circuit block.

10. The semiconductor device according to claim 8, wherein the first circuit block and the second circuit block are each made up of a plurality of elements having an equal input withstanding voltage.

11. The semiconductor device according to claim 10, wherein the elements of each of the first and second circuit blocks are a plurality of metal oxide semiconductor transistors.

12. The semiconductor device according to claim 11, further comprising:
a first semiconductor region in which a first PN junction is formed by a parasitic PN junction of a given one of the MOS transistors of the first circuit block; and
a second semiconductor region in which a second PN junction is formed by a parasitic PN junction of a given one of the MOS transistors of the second circuit block.

13. The semiconductor device according to claim 11, wherein at least one of the MOS transistors of the first circuit block, to which such an excessive voltage as to break the MOS transistors by electrostatic discharge is applied, has a gate breakdown voltage that is higher than that of other MOS transistors which make up the first circuit block, or at least one of the MOS transistors of the second circuit block, to which such an excessive voltage as to break the MOS transistors by electrostatic discharge is applied, has a gate breakdown voltage that is higher than that of other MOS transistors which make up the second circuit block.

14. The semiconductor device according to claim 11, wherein some of the MOS transistors of the first circuit block, which make up an output circuit of the signal, have a gate breakdown voltage that is higher than that of others of the MOS transistors of the first circuit block.

15. The semiconductor device according to claim 8, wherein the first power supply voltage and the second power supply voltage are equal to each other.

16. The semiconductor device according to claim 8, wherein the first power supply voltage and the second power supply voltage differ from each other.

17. The semiconductor device according to claim 8, further comprising an electrostatic discharge protection circuit connected to the first and second power supply terminals and the first and second ground terminals.

18. A semiconductor device comprising:
a first circuit block including a first power supply terminal and a first ground terminal, a first power supply voltage being applied between the first power supply terminal and the first ground terminal from a first power domain;
a second circuit block including a second power supply terminal and a second ground terminal, a second power supply voltage being applied between the second power supply terminal and the second ground terminal from a second power domain, at least one of the second power supply terminal and the second ground terminal being provided independently of one of the first power supply terminal and the first ground terminal; and
a propagation circuit provided between an output terminal of the first circuit block and an input terminal of the second circuit block to propagate a signal,
wherein:
the first and second circuit blocks are each made up of a plurality of elements having an equal input withstanding voltage; and
at least one of the elements of the first circuit block, to which such an excessive voltage as to break the elements by electrostatic discharge is applied, has an input withstanding voltage that is higher than that of other elements which make up the first circuit block, or at least one of the elements of the second circuit block, to which such an excessive voltage as to break the elements by electrostatic discharge is applied, has an input withstanding voltage that is higher than that of other elements which make up the second circuit block.

19. The semiconductor device according to claim 18, wherein the propagation circuit is a signal line which connects a first semiconductor region which forms a first PN junction in the first circuit block and a second semiconductor region which forms a second PN junction in the second circuit block.

20. The semiconductor device according to claim 19, wherein the propagation circuit includes a resistive element connected between the first semiconductor region and the second semiconductor region.

21. The semiconductor device according to claim 18, wherein the elements of each of the first and second circuit blocks are a plurality of MOS transistors.

22. The semiconductor device according to claim 21, further comprising:
a first semiconductor region in which a first PN junction is formed by a parasitic PN junction of a given one of the MOS transistors of the first circuit block; and
a second semiconductor region in which a second PN junction is formed by a parasitic PN junction of a given one of the MOS transistors of the second circuit block.

23. The semiconductor device according to claim 18, wherein the first power supply voltage and the second power supply voltage are equal to each other.

24. The semiconductor device according to claim 18, wherein the first power supply voltage and the second power supply voltage differ from each other.

25. The semiconductor device according to claim 18, further comprising an electrostatic discharge protection circuit connected to the first and second power supply terminals and the first and second ground terminals.
